(19) United States
(12) Patent Application Publication
(10) Pub. No.: US 2019/0061410 A1
(43) Pub. Date: Feb. 28, 2019

(54) TAB STRIP SEGMENTS, PLURALITIES OF INTERCONNECTED TABS, FASTENING DEVICES THAT UTILIZE THE SAME, AND METHODS OF FORMING THE SAME

(71) Applicant: Columbia River Staple & Lumber Wrap, Inc., Sherwood, OR (US)

(72) Inventors: Waylon Bleu Burlingame, Tigard, OR (US); Mark Stanley Burlingame, Sherwood, OR (US)

(21) Appl. No.: 15/683,662

(22) Filed: Aug. 22, 2017

(51) Int. Cl. B42F 21/04; B65B 13/02; B65B 13/30

(52) U.S. Cl. CPC B42F 21/04; F16B 15/0015; B65B 13/305; B65B 13/025

(57) ABSTRACT

Tab strip segments, pluralities of interconnected tabs, fastening devices that utilize the same, and methods of forming the same. The tab strip segments include a plurality of interconnected central tabs, an interconnected leading tab, an interconnected trailing tab, and a plurality of tab attachment structures. The interconnected leading tab defines a first portion of a strip interlock structure. The interconnected trailing tab defines a second portion of the strip interlock structure. The first portion of the strip interlock structure and the second portion of the strip interlock structure of separate tab strip segments are configured to overlap and interlock with one another to define a tab strip. The methods include providing a plurality of tab strip segments and interlocking the plurality of tab strip segments, via corresponding first and second portions of the strip interlock structure to form the plurality of interconnected tabs.

### FIELD OF THE DISCLOSURE

The present disclosure relates generally to tab strip segments, to pluralities of interconnected tabs that include the tab strip segments, to fastening devices that utilize the same, and/or to methods of forming the same.

### BACKGROUND OF THE DISCLOSURE

Powered fastening tools, such as pneumatic staplers, may be utilized to secure lumber wrap to lumber. The lumber wrap may be wrapped around lumber and fastened to the lumber, such as with staples or other fasteners, to protect the lumber from environmental or other damage during storage and transport. Tabs may be utilized to reinforce the fasteners, thereby resisting tear-through and retaining the lumber wrap attached to the lumber.

Historically, these tabs were applied manually. Specifically, an operator would hold the tab and utilize a general-purpose staple gun to staple the tabs to the lumber. More recently, special-purpose staple guns have been developed. These special-purpose staple guns may be configured automatically to feed both tabs and staples.

Tabs for these special-purpose staple guns generally are supplied in rolls, with the tabs being operatively attached to a backing paper to facilitate formation of the roll of tabs. While such a configuration may be effective in some circumstances, it may be costly to implement. In addition, the roll of tabs may be bulky, thereby increasing an overall size of and/or decreasing operator comfort when utilizing special-purpose staple guns configured to utilize rolls of tabs. Thus, there exists a need for improved tab strip segments, for pluralities of interconnected tabs, for fastening devices that utilize the same, and/or for methods of forming the same.

### SUMMARY OF THE DISCLOSURE

Tab strip segments, pluralities of interconnected tabs, fastening devices that utilize the same, and methods of forming the same. The tab strip segments include a plurality of interconnected central tabs, an interconnected leading tab, an interconnected trailing tab, and a plurality of tab attachment structures. The interconnected leading tab is arranged at a first end of the plurality of interconnected central tabs and defines a first portion of a strip interlock structure. The interconnected trailing tab is arranged at an opposed second end of the plurality of interconnected tabs and defines a second portion of the strip interlock structure. The plurality of tab attachment structures attaches the plurality of interconnected central tabs, the interconnected leading tab, and the interconnected trailing tab. The interconnected leading tab and the interconnected trailing tab of separate tab strip segments are configured to overlap with one another such that the first portion of the strip interlock structure of one tab strip segment and the second portion of the strip interlock structure of another tab strip segment interlock with one another to facilitate assembly of a plurality of tab strip segments to define a tab strip.

The pluralities of interconnected tabs include a plurality of tab strip segments. The plurality of tab strip segments includes at least one central tab strip segment, a leading tab strip segment, and a trailing tab strip segment. The at least one central tab strip segment extends between, and operatively interconnects, the leading tab strip segment and the trailing tab strip segment.

The pluralities of interconnected tabs may be folded to define accordion-folded stacks of tabs. Within the accordion-folded stacks of tabs, the pluralities of interconnected tabs are arranged in a plurality of tab layers, and each tab layer is operatively attached to at least one other tab layer via a corresponding tab attachment structure.

The fastening devices include a handle, a trigger mechanism, a fastener magazine, a fastening head, and a tab feed structure. The tab feed structure is configured to contain a first subset of a plurality of interconnected tabs. The tab feed structure also is configured to selectively advance a tab strip, which is formed from a second subset of the plurality of interconnected tabs, toward a fastening region.

The methods include providing a plurality of tab strip segments and interlocking the plurality of tab strip segments to form a plurality of interconnected tabs. The interlocking includes repeatedly interlocking a first portion of a strip interlock structure, which is defined by an interconnected leading tab of a given tab strip segment, with a second portion of the strip interlock structure, which is defined by an interconnected trailing tab of an adjacent (separate) tab strip segment.

### BRIEF DESCRIPTION OF THE DRAWINGS

FIG. 1 is a schematic representation of examples of fastening devices according to the present disclosure.

FIG. 2 is a schematic side view illustrating examples of tab strip segments according to the present disclosure.

FIG. 3 is a schematic top view illustrating examples of tab attachment structures that may be utilized with tab strip segments according to the present disclosure.

FIG. 4 is a schematic top view illustrating examples of tab attachment structures that may be utilized with tab strip segments according to the present disclosure.

FIG. 5 is a schematic top view illustrating an example of a tab attachment structure that may be utilized with tab strip segments according to the present disclosure.

FIG. 6 is a schematic side view illustrating examples of tab attachment structures that may be utilized with tab strip segments according to the present disclosure.

FIG. 7 is a less schematic top view illustrating an example of a tab strip segment according to the present disclosure.

FIG. 8 is a less schematic side view of the tab strip segment of FIG. 7.

FIG. 9 is a less schematic profile view illustrating a top surface of the tab strip segment of FIG. 7.

FIG. 10 is a less schematic profile view illustrating a bottom surface of the tab strip segment of FIG. 7.

FIG. 11 is a less schematic top view illustrating an example of a tab strip segment according to the present disclosure.

FIG. 12 is a less schematic side view of the tab strip segment of FIG. 11.

FIG. 13 is a less schematic profile view illustrating a top surface of the tab strip segment of FIG. 11.

FIG. 14 is a less schematic profile view illustrating a bottom surface of the tab strip segment of FIG. 11.

FIG. 15 is a schematic side view illustrating examples of pluralities of interconnected tabs according to the present disclosure.

FIG. 16 is a schematic side view illustrating an example of a strip interlock structure according to the present disclosure.

FIG. 17 is a schematic side view illustrating an example of a strip interlock structure according to the present disclosure.

FIG. 18 is a schematic side view illustrating an example of a strip interlock structure according to the present disclosure.

FIG. 19 is a schematic side view illustrating an example of a strip interlock structure according to the present disclosure.

FIG. 20 is a schematic side view illustrating an example of a strip interlock structure according to the present disclosure.

FIG. 21 is a schematic side view illustrating an example of a strip interlock structure according to the present disclosure.

FIG. 22 is a schematic side view illustrating an example of an accordion-folded stack of tabs according to the present disclosure.

FIG. 23 is a schematic side view illustrating an example of an accordion-folded stack of tabs according to the present disclosure.

FIG. 24 is a schematic side view illustrating an accordion-folded stack of tabs contained within a tab magazine, according to the present disclosure.

FIG. 25 is a flowchart depicting examples of methods of forming a plurality of interconnected tabs, according to the present disclosure.

### DETAILED DESCRIPTION AND BEST MODE OF THE DISCLOSURE

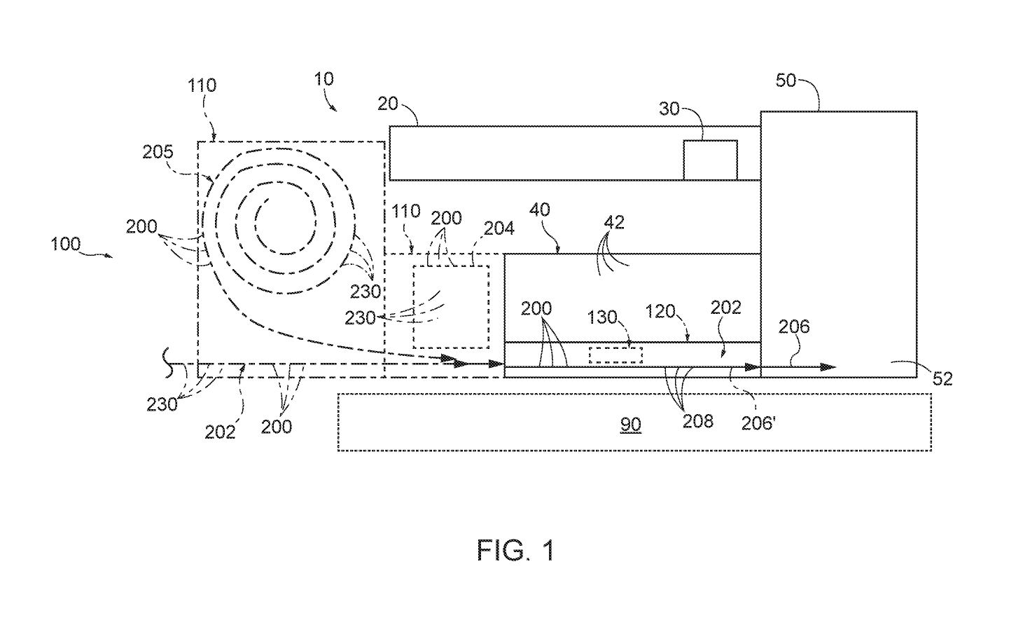

FIGS. 1-25 provide examples of tab strip segments 230, of pluralities of interconnected tabs 200, of accordion-folded stacks of tabs 204, of fastening devices 10 that utilize the same, and/or of methods 400 of forming the same, according to the present disclosure. Elements that serve a similar, or at least substantially similar, purpose are labeled with like numbers in each of FIGS. 1-25, and these elements may not be discussed in detail herein with reference to each of FIGS. 1-25. Similarly, all elements may not be labeled in each of FIGS. 1-25, but reference numerals associated therewith may be utilized herein for consistency. Elements, components, and/or features that are discussed herein with reference to one or more of FIGS. 1-25 may be included in and/or utilized with any of FIGS. 1-25 without departing from the scope of the present disclosure. In general, elements that are likely to be included in a particular embodiment are illustrated in solid lines, while elements that are optional are illustrated in dashed lines. However, elements that are shown in solid lines may not be essential and, in some embodiments, may be omitted without departing from the scope of the present disclosure.

As discussed, tabs may be utilized to reinforce fasteners, to resist tear-through, and/or to retain thin sheet material, such as lumber wrap, attached to a workpiece, such as lumber. As also discussed, these tabs generally are affixed to the workpiece via a fastening device, or a special-purpose fastening device, that may be configured hold, contain, and/or house both a plurality of tabs and a plurality of fasteners. Such fastening devices also may be configured to operatively affix one or more tabs to the workpiece with, via, and/or utilizing the fastener.

FIG. 1 is a schematic representation of examples of fastening devices 10 that may be utilized with tab strip segments 230, and/or pluralities of interconnected tabs 200, according to the present disclosure. Examples of fastening device 10 include any suitable pneumatic, electric, and/or cordless stapler, nailer, and/or other fastening device.

As illustrated in FIG. 1, fastening devices 10 include a handle 20, which is configured to be gripped by a user, and a trigger mechanism 30, which is configured to be actuated by the user. Fastening devices 10 also include a fastener magazine 40, which is configured to contain a plurality of fasteners 42, and a fastening head 50 that defines a fastening region 52.

As further illustrated in FIG. 1, fastening devices 10 also include a tab feed structure 100. Tab feed structure 100 is configured to selectively advance a tab strip 202, which is formed from at least a first subset, portion, and/or fraction of the plurality of interconnected tabs 200, toward fastening region 52. The plurality of interconnected tabs 200 may include a plurality of indexing structures 208.

As illustrated in dash-dot lines in FIG. 1, tab strip 202 may be provided to, or may feed into, tab feed structure 100. Additionally or alternatively, and as illustrated in dashed and also in dash-dot-dot lines in FIG. 1, tab feed structure 100 may contain a second subset, portion, and/or fraction of the plurality of interconnected tabs 200. As an example, tab feed structure 100 may include a tab magazine 110 that contains the second subset of the plurality of interconnected tabs. Tab magazine 110 may be configured to contain an accordion-folded stack of tabs 204, as illustrated in dashed lines in FIG. 1. Additionally or alternatively, tab magazine 110 may be configured to contain a roll of tabs 205, as illustrated in dash-dot-dot lines in FIG. 1. Additionally or alternatively, tab magazine 110 may be configured to contain a stored tab strip 202, or at least a portion thereof, as illustrated in dash-dot lines in FIG. 1.

As also illustrated in dashed lines in FIG. 1, tab feed structure 100 may include a feed rail 120, which also may be referred to herein as a tab feed rail 120 and/or as a tab strip feed rail 120. Feed rail 120 may be configured to receive a tab strip 202, such as from tab magazine 110, and/or to direct the tab strip, such as from the tab magazine, toward and/or into fastening region 52.

As also illustrated in dashed lines in FIG. 1, tab feed structure 100 further may include a tab advance mechanism 130. Tab advance mechanism 130 may be configured to selectively advance tab strip 202 toward and/or into fastening region 52, such as via operative engagement with indexing structures 208.

A leading tab 206 in the plurality of interconnected tabs 200 may extend between a workpiece 90 and fastening region 52, such as from and/or via feed rail 120, when present. During operation of fastening device 10, a user may grip and/or hold fastening device 10 via handle 20 and may actuate trigger mechanism 30, such as with a user's finger. Upon, or responsive to, actuation of trigger mechanism 30, fastening devices 10 may utilize fastening head 50 to urge a fastener 42, within fastening region 52, through leading tab 206, and into workpiece 90, thereby operatively affixing leading tab 206 to workpiece 90. The actuation of trigger mechanism 30 also may separate leading tab 206 from the plurality of interconnected tabs 200 and/or from tab strip 202, thereby defining a new, or subsequent, leading tab 206′. Subsequently, tab feed structure 100, such as via tab advance mechanism 130 thereof, may advance tab strip 202 toward fastening region 52, thereby positioning new leading tab 206′ between workpiece 90 and fastening region 52. This process may be repeated any suitable number of times to operatively affix any suitable number of leading tabs 206/206′ to workpiece 90, or to another workpiece 90, with corresponding fasteners 42.

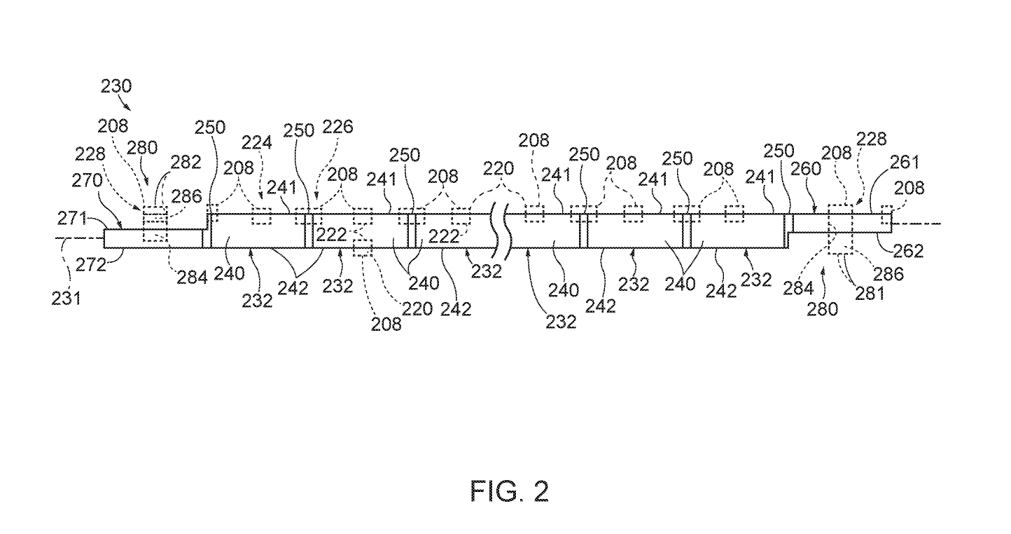

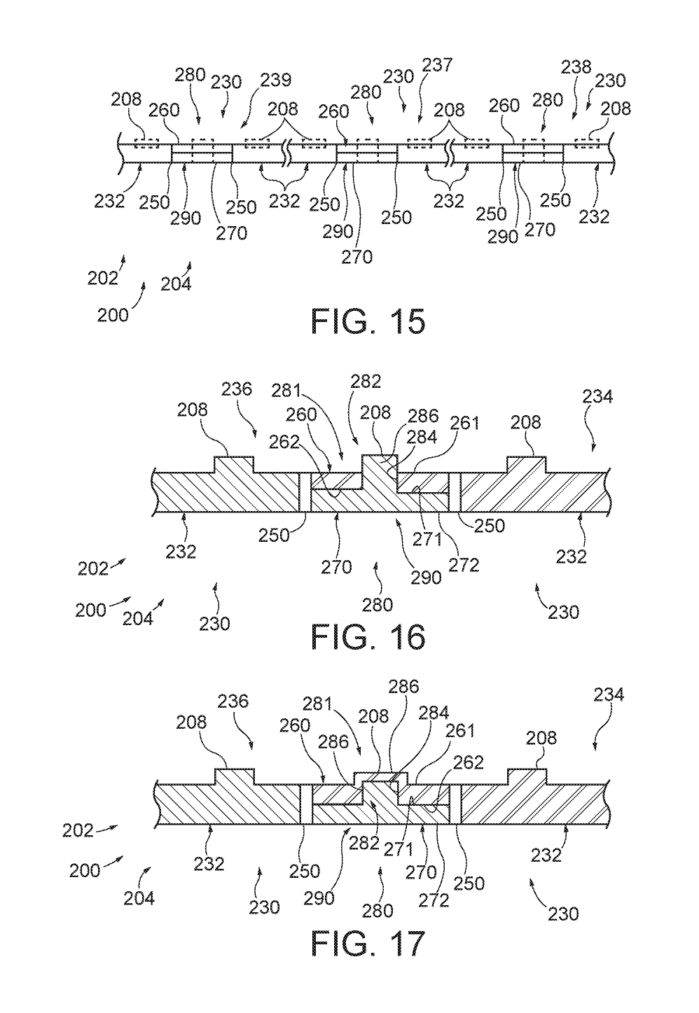

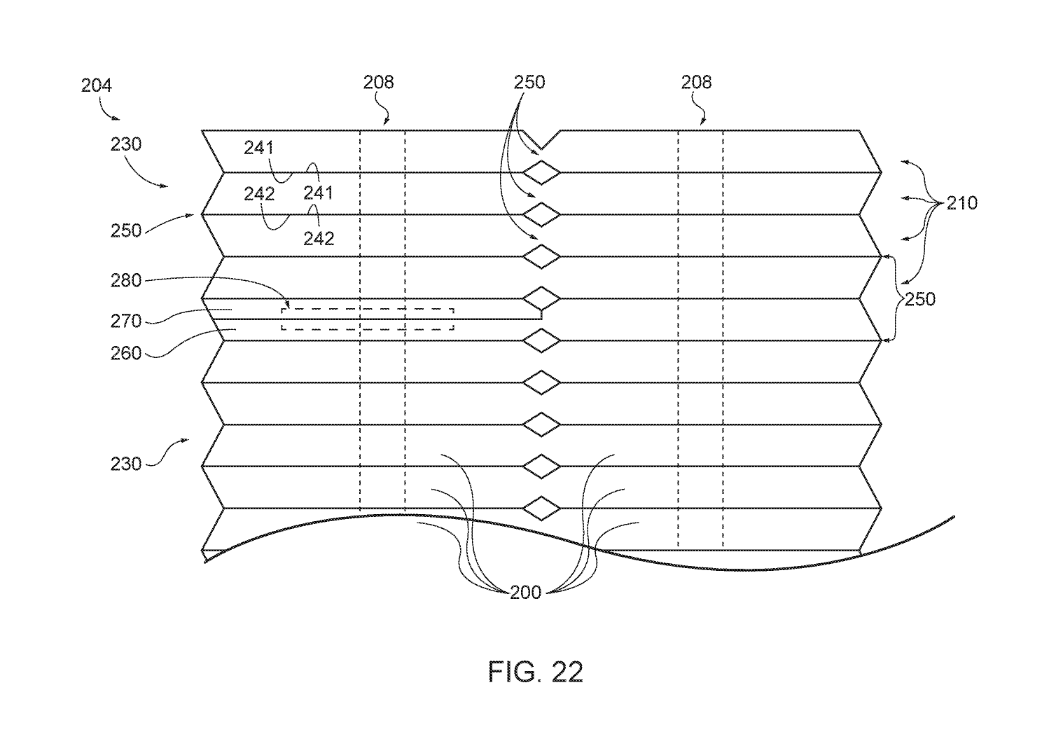

Examples of tab strip segments 230 are discussed in more detail herein with reference to FIGS. 2-14. Examples of pluralities of interconnected tabs 200 are discussed in more detail herein with reference to FIGS. 15-21. Examples of accordion-folded stacks of tabs 204 are discussed in more detail herein with reference to FIGS. 22-24.

Examples of fastening devices, of general-purpose staple guns, and/or of special-purpose staple guns that may include and/or utilize accordion-folded stacks of tabs 204, pluralities of interconnected tabs 200, and/or tab strip segments 230, according to the present disclosure, are disclosed in U.S. patent application Ser. No. 15/621,760, which is entitled FASTENING DEVICES AND METHODS OF UTILIZING THE SAME and was filed on Jun. 13, 2017. Additional examples of conventional fastening devices, of general-purpose staple guns, and/or of special-purpose staple guns that may include and/or utilize accordion-folded stacks of tabs 204, pluralities of interconnected tabs 200, and/or tab strip segments 230, according to the present disclosure, are disclosed in U.S. Pat. Nos. 8,485,410, 7,963,428, 6,837,412, 6,834,731, 6,550,660, and 5,925,214 and in U.S. Patent Application Publication Nos. 2008/0164278, 2004/0251264, and 2003/0197046. The complete disclosures of these patents, patent application, and patent application publications are hereby incorporated by reference.

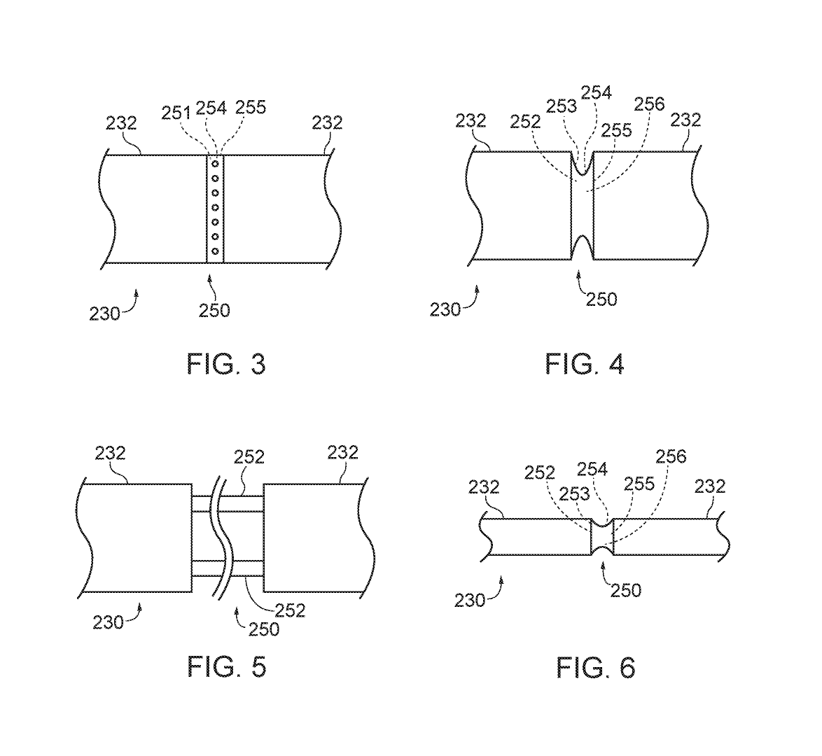

FIG. 2 is a schematic side view illustrating examples of tab strip segments 230 according to the present disclosure. FIGS. 3-14 are more detailed and/or less schematic illustrations of structures that may be included in and/or utilized with tab strip segments 230. Any of the structures, functions, and/or features that are disclosed herein with reference to any one or more of FIGS. 2-14 may be included and/or utilized with any other of FIGS. 2-14 without departing from the scope of the present disclosure. In addition, any of the structures, functions, and/or features of tab strip segments 230 disclosed herein with reference to any of FIGS. 2-14 may be included in and/or utilized with fastening devices 10 and/or tab strip segments 230 thereof of FIG. 1.

As illustrated in FIG. 2, tab strip segments 230 include a plurality of interconnected central tabs 232, an interconnected leading tab 260, and an interconnected trailing tab 270. Tab strip segments 230 also include a plurality of tab attachment structures 250. Tab attachment structures 250 operatively attach the plurality of interconnected central tabs 232, the interconnected leading tab 260, and the interconnected trailing tab 270 to one another to form and/or define tab strip segment 230. Within tab strip segment 230, interconnected leading tab 260 is arranged at a first end of the plurality of interconnected central tabs 232, and interconnected trailing tab 270 is arranged at an opposed second end of the plurality of interconnected central tabs 232.

Each interconnected central tab 232 includes a tab body 240, which in some embodiments may be planar, or at least substantially planar, and in such embodiments also may be referred to herein as and/or may be a planar tab body 240. Tab body 240 includes a first tab body surface 241, which also may be referred to herein as and/or may be a first planar tab body surface 241, and a second tab body surface 242, which also may be referred to herein as and/or may be a second planar tab body surface 242. Second tab body surface 242 may be opposed to, or on an opposite side of tab body 240 from, first tab body surface 241. Additionally or alternatively, first tab body surface 241 may be parallel, or at least substantially parallel, to second tab body surface 242.

It is within the scope of the present disclosure that interconnected central tabs 232 and/or tab bodies 240 thereof may be flat and/or may have a thickness that is significantly less than a characteristic dimension of first tab body surface 241 and/or of second tab body surface 242. An example of the characteristic dimension includes a maximum extent of the first tab body surface and/or of the second tab body surface. Under these conditions, the maximum extent of the first tab body surface and/or of the second tab body surface may be at least a threshold multiple of the thickness of interconnected central tabs 232, as measured between the first tab body surface and the second tab body surface. Examples of the threshold multiple include threshold multiples of at least 5, at least 10, at least 25, at least 50, at least 100, at most 1000, at most 750, at most 500, at most 250, and/or at most 100.

Each interconnected central tab 232 also includes, forms, and/or defines at least a portion of an indexing structure 208. As discussed herein, indexing structure 208 is configured to be operatively engaged by a tab advance mechanism, such as tab advance mechanism 130 of FIG. 1, of a fastening device, such as fastening device 10 of FIG. 1. The at least a portion of indexing structure 208 extends from at least one, and optionally both, of first tab body surface 241 and second tab body surface 242. Examples of indexing structures 208 are discussed in more detail herein.

Interconnected leading tab 260 defines a first leading tab surface 261, which also may be referred to herein as and/or may be a first planar leading tab surface 261. Interconnected leading tab 260 also defines a second leading tab surface 262, which also may be referred to herein as and/or may be a second planar leading tab surface 262. Interconnected leading tab 260 further forms and/or defines a first portion 281 of a strip interlock structure 280. Examples of strip interlock structure 280 are discussed in more detail herein.

Interconnected trailing tab 270 defines a first trailing tab surface 271, which also may be referred to herein as and/or may be a first planar trailing tab surface 271. Interconnected trailing tab 270 also defines a second trailing tab surface 272, which also may be referred to herein as and/or may be a second planar trailing tab surface 272. Interconnected trailing tab 270 further forms and/or defines a second portion 282 of strip interlock structure 280.

Interconnected leading tab 260 may have and/or define a thickness, which may be measured and/or defined between first leading tab surface 261 and second leading tab surface 262. Similarly, interconnected trailing tab 270 may have and/or define a thickness, which may be measured and/or defined between first trailing tab surface 271 and second trailing tab surface 272. It is within the scope of the present disclosure that a combined thickness of the interconnected leading tab and the interconnected trailing tab may be matched, or at least substantially matched, to the thickness of interconnected central tabs 232. As examples, a ratio of the combined thickness to the thickness of the interconnected central tabs may be at least 0.75, at least 0.80, at least 0.85, at least 0.90, at least 0.95, at least 0.99, 1.00, at most 1.01, at most 1.05, at most 1.10, at most 1.15, at most 1.20, and/or at most 1.25.

It is also within the scope of the present disclosure that one or more of a first leading tab surface area of the first leading tab surface, a second leading tab surface area of the second leading tab surface, a first tab body surface area of the first tab body surface, a second tab body surface area of the second tab body surface, a first trailing tab surface area of the first trailing tab surface, and/or a second trailing tab surface area of the second trailing tab surface area of the second trailing tab surface may be matched, or at least substantially matched, to one another. As more specific examples, a ratio of one of the first leading tab surface area, the second leading tab surface area, the first tab body surface area, the second tab body surface area, the first trailing tab surface area, and the second trailing tab surface area to one or more others of the first leading tab surface area, the second leading tab surface area, the first tab body surface area, the second tab body surface area, the first trailing tab surface area, and the second trailing tab surface area may be at least 0.75, at least 0.80, at least 0.85, at least 0.90, at least 0.95, at least 0.99, 1.00, at most 1.01, at most 1.05, at most 1.10, at most 1.15, at most 1.20, and/or at most 1.25.

Indexing structures 208 may include any suitable structure that may be adapted, configured, designed, shaped, and/or constructed to be operatively engaged by the tab advance mechanism of the fastening device. Additionally or alternatively, indexing structures 208 may include any suitable structure that may extend from the first tab body surface and/or from the second tab body surface.

As an example, and as illustrated in FIG. 2, indexing structures 208 may include a projection 220. Projection 220 may be defined by tab body 240, may project from first tab body surface 241, and/or may project from second tab body surface 242. As another example, and as also illustrated in FIG. 2, indexing structures 208 may include a recess 222. Recess 222 may be defined within tab body 240, may be defined by tab body 240, may extend from first tab body surface 241, and/or may extend from second tab body surface 242.

FIG. 2 illustrates indexing structures 208 in dashed lines to indicate that the indexing structures, while generally present within tab strip segments 230, may have any suitable form, shape, location, and/or spatial distribution within the tab strip segments. As an example, and as indicated at 224, a given indexing structure 208 may be defined, or entirely defined, by a given, or a single, tab body 240. As another example, and as indicated at 226, a given indexing structure 208 may be defined, or entirely defined, by a pair of adjacent tab bodies 240. As yet another example, and as indicated at 228, interconnected leading tab 260 and/or interconnected trailing tab 270 may define a corresponding indexing structure 208.

Indexing structures 208 may be spaced-apart within tab strip segment 230 in any suitable manner. As an example, each tab body 240 may define a corresponding indexing structure 208. As another example, each tab body 240 may define a plurality of indexing structures 208 and/or a corresponding region of two or more indexing structures 208. In general, and as illustrated, indexing structures 208 are spaced-apart longitudinally along a length of the tab strip segment. Additionally or alternatively, two or more indexing structures may be spaced-apart from one another laterally, or perpendicular to, the length of the tab strip segment.

Tab attachment structures 250 may include any suitable structure that may be adapted, configured, designed, and/or constructed to operatively attach the plurality of interconnected central tabs 232, the interconnected leading tab 260, and the interconnected trailing tab 270 to one another to form and/or define tab strip segment 230. In addition, tab attachment structures 250 generally will be adapted, configured, designed, and/or constructed to permit and/or to facilitate separation of interconnected central tabs 232, interconnected leading tab 260, and/or interconnected trailing tab 270 from tab strip segment 230 when the tab strip segment is utilized within a fastening device, such as fastening device 10 of FIG. 1. Such a configuration may permit and/or facilitate fastening of portions of tab strip segments 230 to a workpiece with a fastener, as discussed herein.

With this in mind, tab attachment structures 250 also may be referred to herein as and/or may be a weakened region of tab strip segments 230, at least when compared to the plurality of interconnected central tabs. Additionally or alternatively, tab attachment structures 250 may be referred to herein as and/or may be a thin region, a reduced cross-sectional area region, and/or a reduced transverse cross-sectional area region of tab strip segments 230, at least when compared to a thickness, to a cross-sectional area, and/or to a transverse cross-sectional area of the plurality of interconnected central tabs.

FIGS. 3-6 are schematic top views illustrating examples of tab attachment structures 250 that may be utilized with tab strip segments 230 according to the present disclosure. As illustrated in FIGS. 3-6, and as discussed, tab attachment structures 250 may interconnect adjacent interconnected central tabs 232 to one another to form and/or define the tab strip segment.

FIG. 3 is a schematic top view illustrating examples of tab attachment structures 250. As illustrated in FIG. 3, tab attachment structures 250 may include and/or be a perforated region 251, a weakened region 254, and/or a reduced cross-sectional area region 255.

FIG. 4 is a schematic top view illustrating examples of tab attachment structures 250. As illustrated in FIG. 4, tab attachment structures 250 may include and/or be a web 252, a thin region 253, weakened region 254, reduced cross-sectional area region 255, and/or a tapered region 256.

FIG. 5 is a schematic top view illustrating another example of a tab attachment structure 250. As illustrated in FIG. 5, tab attachment structures 250 may include a plurality of webs 252 extending between adjacent interconnected central tabs 232.

FIG. 6 is a schematic side view illustrating examples of tab attachment structures 250. Similar to the tab attachment structures of FIG. 4, FIG. 6 illustrates that tab attachment structures 250 may include and/or be webs 252, thin regions 253, weakened regions 254, reduced cross-sectional area regions 255, and/or tapered regions 256.

As discussed in more detail herein, and while not required to all tab attachment structures according to the present disclosure, tab attachment structures 250 may be configured to permit folding of each interconnected central tab 232 relative to each adjacent interconnected central tab 232 across a fold angle of at least 180 degrees. This may include permitting the folding across the fold angle without separation of adjacent interconnected central tabs 232. Additionally or alternatively, this may include permitting the folding across the fold angle to permit, facilitate, and/or establish at least partial, or even complete, face-to-face contact between corresponding surfaces of adjacent interconnected central tabs 232. Stated another way, and as also discussed in more detail herein, tab attachment structures 250, interconnected central tabs 232, interconnected leading tab 260, interconnected trailing tab 270, and/or indexing structures 208 may be adapted, configured, designed, constructed, and/or shaped to permit tab strip segment 230 to be arranged in an accordion-folded fashion.

Returning to FIG. 2, it is within the scope of the present disclosure that tab strip segments 230 may be formed and/or defined in any suitable manner. As an example, tab strip segment 230 may be formed and/or defined by a single, or monolithic, tab strip segment body. Under these conditions, interconnected central tabs 232, interconnected leading tab 260, interconnected trailing tab 270, tab attachment structures 250, and/or indexing structures 208 all may be formed and/or defined by the single, or monolithic, tab strip body. As additional examples, tab strip segments 230 may be referred to herein as and/or may be monolithic tab strip segments 230, unitary tab strip segments 230, extruded tab strip segments 230, and/or injection molded tab strip segments 230.

With continued reference to FIG. 2, tab strip segments 230 may be arranged in a linear fashion. As examples, the plurality of interconnected central tabs, the interconnected leading tab, and/or the interconnected trailing tab may be arranged sequentially and/or in an end-to-end fashion within the tab strip segment. Such a tab strip segment also may be referred to herein as an elongate tab strip segment that defines a longitudinal axis 231.

As illustrated in FIG. 2, each interconnected central tab 232 is operatively attached to at least one and at most two other interconnected central tabs. As also illustrated in FIG. 2, interconnected central tabs 232 extend between, and operatively interconnect, interconnected leading tab 260 and interconnected trailing tab 270.

Tab strip segments 230 may be formed and/or defined from any suitable material and/or materials. As examples, tab strip segments 230 may be formed and/or defined from one or more of a resilient material, a polymeric material, and/or a fibrous material.

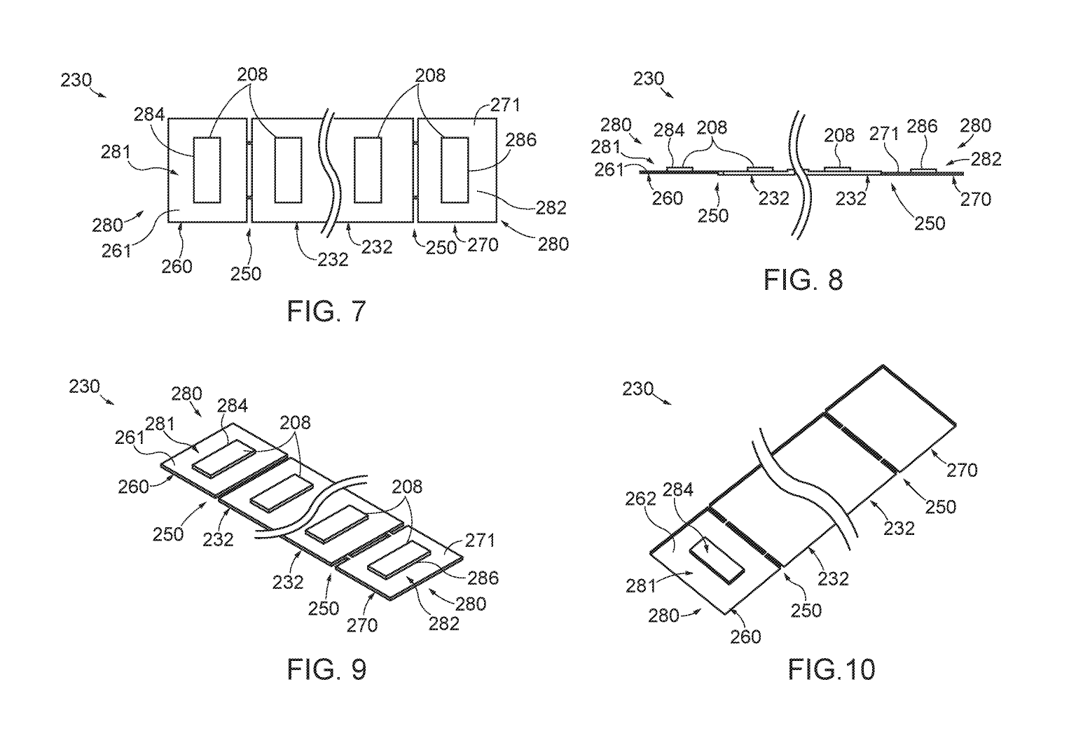

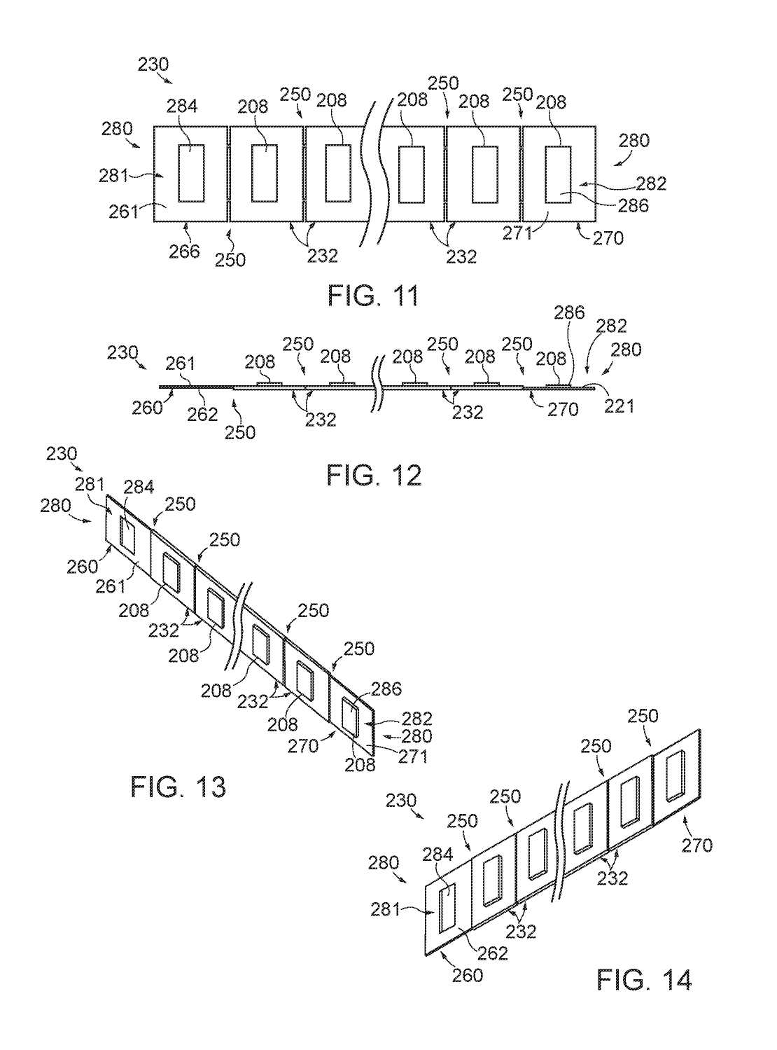

FIGS. 7-14 provide less schematic examples of tab strip segments 230 according to the present disclosure. More specifically, FIGS. 7-10 provide various less schematic views of one example of a tab strip segment 230, while FIGS. 11-14 provide various less schematic views of another example of a tab strip segment 230. Similar to tab strip segments 230 of FIG. 2, tab strip segments 230 of FIGS. 7-14 include a plurality of interconnected central tabs 232, an interconnected leading tab 260, an interconnected trailing tab 270, a plurality of tab attachment structures 250, a plurality of indexing structures 208, and a strip interlock structure 280 that is defined by both interconnected leading tab 260 and interconnected trailing tab 270.

In the example of FIGS. 7-10, and as perhaps best illustrated in FIG. 10, first portion 281 of strip interlock structure 280 includes an interlock structure opening 284, which also may be referred to herein as an interlock structure recess 284. Interlock structure opening 284 extends from second leading tab surface 262 of interconnected leading tab 260. In addition, and as perhaps best illustrated in FIGS. 7-9, first portion 281 of strip interlock structure 280 also includes an interlock structure projection that projects from first leading tab surface 261 of interconnected leading tab 260. The interlock structure projection of interconnected leading tab 260 forms and/or defines an upper surface, or boundary, of interlock structure opening 284.

As perhaps best illustrated in FIGS. 7-8, second portion 282 of strip interlock structure 280 includes another strip interlock structure projection 286 that projects from first trailing tab surface 271 of interconnected trailing tab 270. As illustrated in FIG. 17, and discussed in more detail herein with reference thereto, interlock structure projection 286 of interconnected trailing tab 270 is configured to be received within interlock structure recess 284 of interconnected leading tab 260 when tab strip segments 230 are assembled to form and/or define a tab strip.

In the example of FIGS. 11-14, and as perhaps best illustrated in FIGS. 13-14, first portion 281 of strip interlock structure 280 includes an interlock structure opening 284 that extends through, or through an entirety of, interconnected leading tab 260. Stated another way, interlock structure opening 284 extends between, or entirely between, first leading tab surface 261 and second leading tab surface 262. In addition, and as perhaps best illustrated in FIGS. 12-13, second portion 282 of strip interlock structure 280 includes an interlock structure projection 286 that projects from first trailing tab surface 271 of interconnected trailing tab 270. As illustrated in FIG. 16, and discussed in more detail herein with reference thereto, interlock structure projection 286 is configured to be received within interlock structure recess 284 when tab strip segments 230 are assembled to form and/or define a tab strip.

As discussed in more detail herein, interconnected leading tab 260 and interconnected trailing tab 270 are configured to overlap with one another such that first portion 281 of strip interlock structure 280 and second portion 282 of strip interlock structure 280 interlock with one another. The overlap may include overlapping such that the interconnected leading tab and the interconnected trailing tab are superimposed on top on one another, such that one of the interconnected leading tab and the interconnected trailing tab overlies the other of the interconnected leading tab and the interconnected trailing tab, and/or such that one of the interconnected leading tab and the interconnected trailing tab underlies the other of the interconnected leading tab and the interconnected trailing tab. Additionally or alternatively, the overlap may be such that the interconnected leading tab is in face-to-face contact with the interconnected trailing tab, such as over at least a threshold fraction of a surface area of the interconnected leading tab and/or of the interconnected trailing tab. Examples of the threshold fraction of the surface area include threshold fractions of at least 10%, at least 15%, at least 20%, at least 25%, at least 30%, at least 35%, at least 40%, at least 45%, at most 50%, at most 45%, and/or at most 40%. The interlocking may facilitate assembly of a plurality of tab strip segments 230 to form and/or define a plurality of interconnected tabs that may define a tab strip and/or an accordion-folded stack of tabs, examples of which also are discussed in more detail herein.

FIG. 2 illustrates tab strip segment 230 as including a single strip interlock structure 280 that is defined by a single first portion 281 and a single second portion 282. However, it is within the scope of the present disclosure that tab strip segments 230, which are disclosed herein, may include any suitable number of strip interlock structures 280 that may be defined by any suitable number of first portions 281 and corresponding second portions 282. As an example, tab strip segments 230 may include a plurality of strip interlock structures 280. When tab strip segments 230 include the plurality of strip interlock structures 280, the plurality of first portions 281 and the plurality of second portions 282 may be spaced-apart from one another in any suitable manner within interconnected leading tab 260 and interconnected trailing tab 270, respectively. Examples of this spacing include being spaced-apart longitudinally along the length of the tab strip segment and/or being spaced-apart laterally, or perpendicular to the length of the tab strip segment.

FIGS. 15-21 are schematic side views illustrating examples of pluralities of interconnected tabs 200 formed from tab strip segments 230, according to the present disclosure. Pluralities of interconnected tabs 200 may form and/or define tab strips 202 and/or accordion-folded stacks of tabs 204, as discussed in more detail herein.

Pluralities of interconnected tabs 200 include a plurality of tab strip segments 230. Tab strip segments 230 may include and/or be tab strip segments 230 of FIGS. 2-14, and any of the structures, functions, and/or features discussed herein with reference to tab strip segments 230 of FIGS. 2-14 may be included in and/or utilized with pluralities of interconnected tabs 200 of FIGS. 15-21 without departing from the scope of the present disclosure. Similarly, any of the structures, functions, and/or features of pluralities of interconnected tabs 200 of FIGS. 15-21 may be included in and/or utilized with tab strip segments 230 of FIGS. 2-14 without departing from the scope of the present disclosure.

Interconnection of tab strip segments 230 to form and/or define pluralities of interconnected tabs 200 may be utilized to form and/or define pluralities of interconnected tabs 200 with more interconnected tabs than otherwise might be present utilizing conventional manufacturing techniques. As an example, tab strip segments 230 may be formed by an injection molding process. A number of tabs in such tab strip segments may be limited by a size of the mold utilized in the injection molding process. However, by interconnecting a plurality of tab strip segments, pluralities of interconnected tabs 200 of any desired length may be formed.

As illustrated in FIGS. 15-21, and discussed herein, interconnected leading tabs 260 of a given tab strip segment 230 overlap and interlock with interconnected trailing tabs 270 of an adjacent tab strip segment 230 to form and/or define pluralities of interconnected tabs 200. As perhaps best illustrated in FIG. 15, the plurality of tab strip segments 230, which is combined to define the plurality of interconnected tabs 200, includes at least one central tab strip segment 237 (and often a plurality of central tab strip segments 237), a leading tab strip segment 238, and a trailing tab strip segment 239. The at least one central tab strip segment 237 interconnects leading tab strip segment 238 and trailing tab strip segment 239, such as via and/or utilizing a plurality of corresponding strip interlock structures 280.

As perhaps best illustrated in FIGS. 16-21, and within interconnected tabs 200, first portion 281 of strip interlock structure 280 of an interconnected leading tab 260 of a first tab strip segment 234 may be interlocked with second portion 282 of strip interlock structure 280 of an interconnected trailing tab 270 of a second, or of an adjacent, tab strip segment 236. In general, strip interlock structure 280 may be configured for a frictional and/or interference fit, or interlocking, between first portion 281 and second portion 282 and may include one or more projections, recesses, and/or friction-enhancing regions configured to increase friction between the first portion and the second portion and/or to decrease a potential for separation of the first portion and the second portion subsequent to assembly thereof.

This interlocking may be such that the interconnected leading tab of the first tab strip segment and the interconnected trailing tab of the second tab strip segment overlap with one another and/or define a composite tab 290. Stated another way, this interlocking may be such that second leading tab surface 262 and first trailing tab surface 271 are parallel to one another, face toward one another, and/or are in direct physical contact with one another. When the plurality of tab strip segments is assembled to define the tab strip, composite tab 290 may be referred to herein as operatively interconnecting, or joining, a first plurality of interconnected central tabs, such as of the first tab strip segment, with a second plurality of interconnected central tabs, such as of the second tab strip segment.

A shape, or an external shape, of the composite tab may be similar, at least substantially similar, and/or matched to a shape, or an external shape, of the interconnected central tabs. Additionally or alternatively, the composite tab may form and/or define a composite tab indexing structure that may be similar, at least substantially similar, and/or matched to the indexing structures of the interconnected central tabs. Additionally or alternatively, a thickness of the composite tab may be similar, at least substantially similar, and/or matched to a thickness of each of the interconnected central tabs.

It is within the scope of the present disclosure that pluralities of interconnected tabs 200 may include any suitable number of tab strip segments 230 and/or any suitable number of interconnected tabs, such as may be defined by interconnected central tabs 232 and/or by composite tabs 290. As examples, pluralities of interconnected tabs 200 may include at least 2, at least 5, at least 10, at least 20, at least 30, at least 40, or at least 50 tab strip segments 230. As additional examples pluralities of interconnected tabs 200 may include at least 10, at least 25, at least 50, at least 100, at least 200, at least 300, at least 400, or at least 500 interconnected tabs.

With continued reference to FIGS. 16-21, one of first portion 281 and second portion 282 of strip interlock structure 280 may include, form, and/or define an interlock structure opening 284 that may be defined within a corresponding one of interconnected leading tab 260 and interconnected trailing tab 270. In addition, the other of first portion 281 and second portion 282 of strip interlock structure 280 may include, form, and/or define an interlock structure projection 286 that projects from a corresponding one of interconnected leading tab 260 and interconnected trailing tab 270. Under these conditions, and as illustrated in FIGS. 15-21, interlock structure projection 286 may be shaped, constructed, and/or sized to be received within, to be retained within, and/or to interlock with interlock structure opening 284.

FIG. 16 illustrates an example of strip interlock structures 280 in which first portion 281 of strip interlock structure 280, which is defined by interconnected leading tab 260, includes interlock structure opening 284, while second portion 282 of strip interlock structure 280, which is defined by interconnected trailing tab 270, includes interlock structure projection 286. In the example of FIG. 16, interlock structure opening 284 extends between first leading tab surface 261 and second leading tab surface 262 such that interlock structure projection 286 projects from, or above, first leading tab surface 261. As such, interlock structure projection 286 also forms and/or defines at least a portion, or even all, of indexing structure 208 for composite tab 290.

FIG. 17 illustrates an example of strip interlock structures 280 in which first portion 281 of strip interlock structure 280, which is defined by interconnected leading tab 260, includes interlock structure opening 284, while second portion 282 of strip interlock structure 280, which is defined by interconnected trailing tab 270, includes interlock structure projection 286. In the example of FIG. 16, interlock structure opening 284 extends from second leading tab surface 262, and interlock structure projection 286 is received within the interlock structure opening to operatively attach adjacent tab strip segments 230 to one another. However, and in contrast with the strip interlock structure of FIG. 16, first portion 281 of FIG. 17 also includes a corresponding interlock structure projection 286, and the interlock structure projection of first portion 281 forms and/or defines at least a portion, or even all, of indexing structure 208 for composite tab 290.

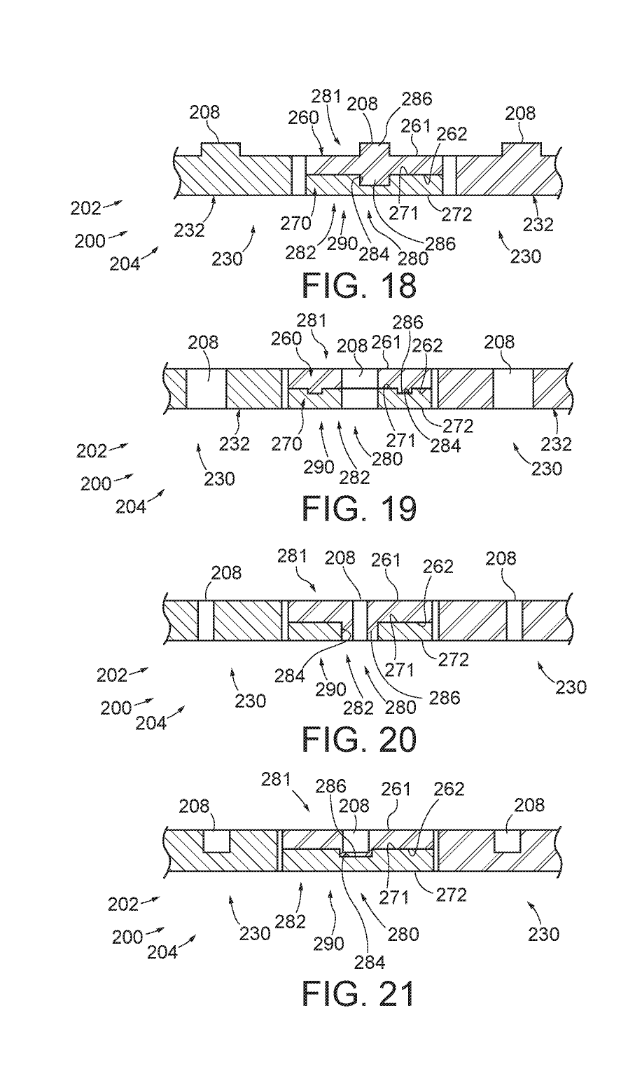

FIG. 18 illustrates an example of strip interlock structures 280 in which first portion 281 of strip interlock structure 280, which is defined by interconnected leading tab 260, includes a first interlock structure projection 286, which projects from first leading tab surface 261, and also a second interlock structure projection 286, which projects from second leading tab surface 262. In addition, second portion 282 of strip interlock structure 280, which is defined by interconnected trailing tab 270, includes interlock structure recess 284. In the example of FIG. 18, the second interlock structure projection is received within the interlock structure recess to operatively attach tab strip segments 230 to one another. In addition, the second interlock structure projection forms and/or defines at least a portion, or even all, of indexing structure 208 for composite tab 290.

FIG. 19 illustrates an example of strip interlock structures 280 in which first portion 281 of strip interlock structure 280, which is defined by interconnected leading tab 260, includes a pair of interlock structure projections 286 that project from second leading tab surface 262. In addition, second portion 282 of strip interlock structure 280, which is defined by interconnected trailing tab 270, includes a corresponding pair of interlock structure recesses 284. In the example of FIG. 19, the pair of interlock structure projections is received within the pair of interlock structure recesses to operatively attach adjacent tab strip segments 230 to one another. In addition, indexing structure 208 is defined by a corresponding recess that extends from first leading tab surface 261, from second leading tab surface 262, from first trailing tab surface 271, and/or from second trailing tab surface 272.

FIG. 20 illustrates an example of strip interlock structures 280 in which first portion 281 of strip interlock structure 280, which is defined by interconnected leading tab 260, includes an interlock structure projection 286 that projects from second leading tab surface 262. In addition, second portion 282 of strip interlock structure 280, which is defined by interconnected trailing tab 270, includes an interlock structure recess 284 that extends between first interconnected trailing tab surface 271 and second interconnected trailing tab surface 272. In the example of FIG. 20, the interlock structure projection is received within the interlock structure recess to operatively attach adjacent tab strip segments 230 to one another. In addition, indexing structure 208 is defined by a corresponding recess that extends from first leading tab surface 261.

FIG. 21 illustrates an example of strip interlock structures 280 in which first portion 281 of strip interlock structure 280, which is defined by interconnected leading tab 260, includes an interlock structure projection 286 that projects from second leading tab surface 262. In addition, second portion 282 of strip interlock structure 280, which is defined by interconnected trailing tab 270, includes an interlock structure recess 284 that extends from first interconnected trailing tab surface 271. In the example of FIG. 20, the interlock structure projection is received within the interlock structure recess to operatively attach adjacent tab strip segments 230 to one another. In addition, indexing structure 208 is defined by a corresponding recess that extends from first leading tab surface 261.

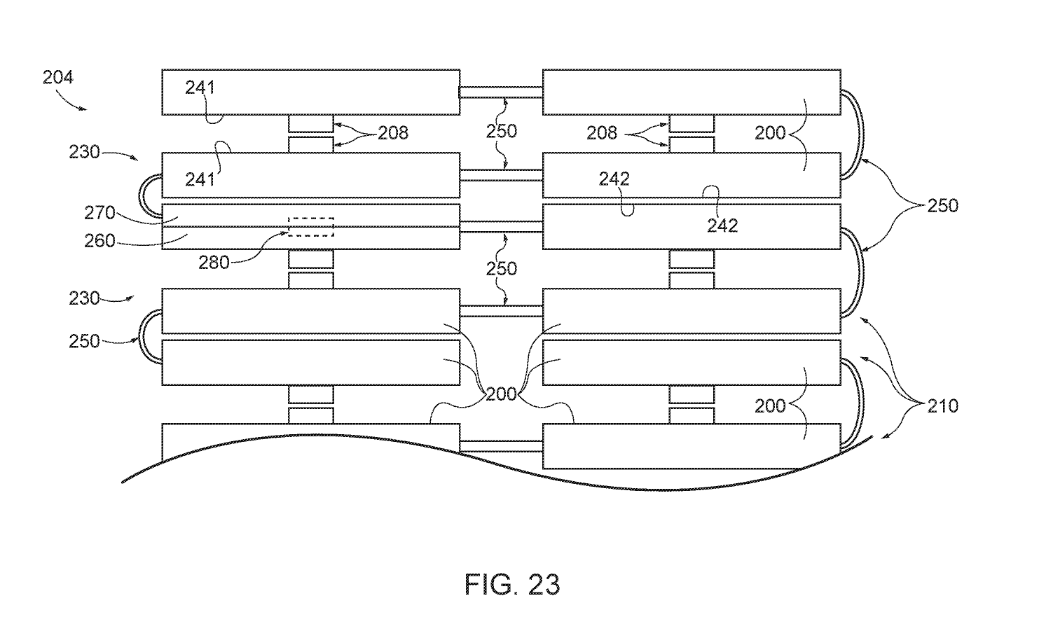

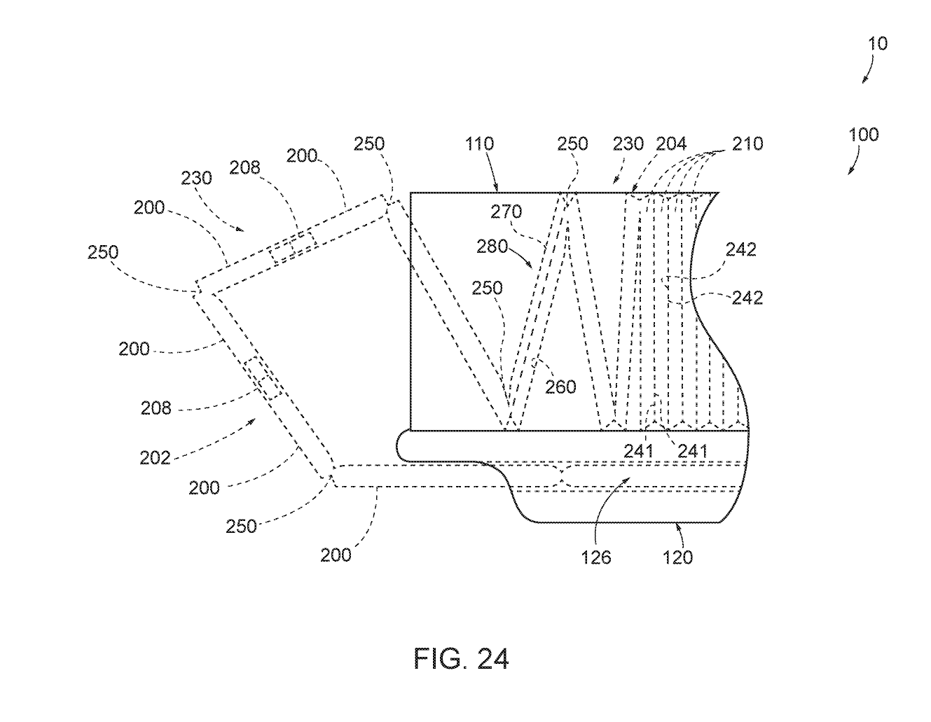

FIGS. 22-24 illustrate accordion-folded stacks of tabs 204 that may, but are not required to, be formed utilizing tab strip segments 230, according to the present disclosure. More specifically, FIG. 22 is a schematic side view illustrating examples of accordion-folded stacks of tabs 204 according to the present disclosure, FIG. 23 is a schematic side view illustrating additional examples of accordion-folded stacks of tabs 204 according to the present disclosure, and FIG. 24 is a schematic side view illustrating an accordion-folded stacks of tabs contained within a tab magazine 110 of a fastening device 10, according to the present disclosure. Accordion-folded stacks of tabs 204 may be formed and/or defined by accordion-folding pluralities of interconnected tabs 200, such as those that are discussed herein with reference to FIGS. 15-21. As such, any of the structures, functions, and/or features of the pluralities of interconnected tabs of FIGS. 15-21 may be included in and/or utilized with accordion-folded stacks of tabs 204 of FIGS. 22-24 without departing from the scope of the present disclosure. Similarly, any of the structures, functions, and/or features of the accordion-folded stacks of tabs of FIGS. 22-24 may be included in and/or utilized with the pluralities of interconnected tabs 200 of FIGS. 15-21 without departing from the scope of the present disclosure.

As illustrated in FIGS. 22-24, accordion-folded stacks of tabs 204 include a plurality of interconnected tabs 200 arranged in a plurality of tab layers 210, with each tab layer 210 being defined by a corresponding subset of the plurality of interconnected tabs. As also illustrated, each tab layer in the plurality of tab layers is operatively attached to at least one other tab layer in the plurality of tab layers via a corresponding tab attachment structure 250. Tab layers 210 may be parallel, or at least substantially parallel, to one another. Such a configuration may increase a storage density of the plurality of interconnected tabs for a given volume when compared to conventional rolls of tabs.

Additionally or alternatively, tab layers 210 may face toward, may be in contact with, may be in face-to-face contact with, and/or may be in physical contact with one another. As an example, a first tab body surface 241 of the interconnected tabs in a given tab layer may face toward, may be in contact with, may be in face-to-face contact with, and/or may be in physical contact with a corresponding first tab body surface 241 of the interconnected tabs in an adjacent tab layer. Similarly, a second tab body surface 242 of the interconnected tabs in the given tab layer may face toward, may be in contact with, may be in face-to-face contact with, and/or may be in physical contact with a corresponding second tab body surface 242 of the interconnected tabs in the other adjacent tab layer.

It is within the scope of the present disclosure that each tab layer 210 in the plurality of tab layers may include any suitable number of tabs 200. As examples, each tab layer may include 1, 2, 3, 4, 5, at least 1, at least 2, at least 3, at least 4, at least 5, at most 10, at most 8, at most 6, at most 4, and/or at most 2 tabs.

Similarly, accordion-folded stack of tabs 204 may include any suitable number of tab layers 210. As examples, the accordion-folded stack of tabs may include at least 5, at least 10, at last 15, at least 20, at least 25, at least 30, at least 40, at least 50, at least 60, at least 70, at least 80, at least 90, or at least 100 tab layers.

As also illustrated in FIGS. 22-24, strip interlock structures 280 may connect adjacent tab strips 230 that form and/or define the plurality of interconnected tabs. Such a configuration may permit any suitable number of interconnected tabs to be utilized to define accordion-folded stack of tabs 204.

Turning more specifically to FIG. 22, an accordion-folded stack of tabs 204 is illustrated in which tabs 200 are flat, at least substantially flat, planar, and/or at least substantially planar. In such an accordion-folded stack of tabs, and as illustrated in dashed lines, indexing structures 208 may include recesses that extend within corresponding tabs 200. As such, tabs 200 in adjacent layers 210 may be in contact, may be in direct face-to-face contact, and/or may be in direct physical contact with one another. This contact may extend across a substantial portion, or a majority, of a surface area of first tab body surfaces 241 and/or of second tab body surfaces 242.

Turning to FIG. 23, accordion-folded stack of tabs 204 is illustrated in which tabs 200 include indexing structures 208 that project from first tab body surfaces 241 of the tabs. As such, and while indexing structures 208 may contact one another and/or may contact first tab body surfaces 241, the first tab body surfaces 241 face toward, but do not necessarily contact, one another. However, in the illustrated example, second tab body surfaces 242 may be planar and thus may contact one another.

As illustrated in FIG. 23, to accommodate the additional and/or variable spacing between adjacent tab layers 210 due to the presence of indexing structures 208, tab attachment structures 250 may be elongate and/or may be longer than corresponding tab attachment structures 250 in accordion-folded stacks of tabs 204 that do not include projecting indexing structures 208. In this configuration, a length of tab attachment structures 250 specifically may be selected and/or designed to permit and/or facilitate the accordion folding.

Turning to FIG. 24, and as discussed, accordion-folded stacks of tabs 204 may be stored within a tab magazine 110 of a fastening device 10. As also illustrated, a first fraction, or subset, of the plurality of interconnected tabs 200 may form and/or define accordion-folded stack of tabs 204, while a second fraction, or subset, of the plurality of interconnected tabs 200 may extend from the tab magazine as a tab strip 202. The tab strip may feed into a feed channel 126 of a feed rail 120 of the fastening device.

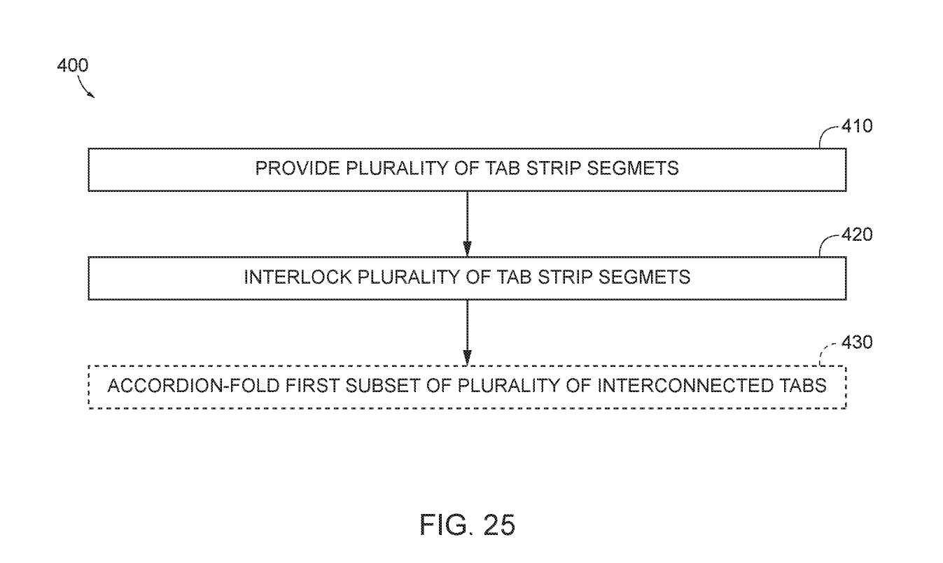

FIG. 25 is a flowchart depicting methods 400 of forming a plurality of interconnected tabs, according to the present disclosure. Methods 400 include providing, at 410, a plurality of tab strip segments and interlocking, at 420, the plurality of tab strip segments. Methods 400 also may include accordion folding, at 430, a first subset of a plurality of interconnected tabs.

Providing, at 410, the plurality of tab strip segments may include providing any suitable tab strip segment. Each tab strip segment may include a plurality of interconnected central tabs, an interconnected leading tab arranged on a first end of the plurality of interconnected central tabs, and an interconnected trailing tab arranged on a second, or on an opposed, end of the plurality of interconnected central tabs. Examples of tab strip segments that may be provided during the providing at 410 are discussed herein with reference to tab strip segments 230.

Interlocking, at 420, the plurality of tab strip segments may include interlocking the plurality of tab strip segments to form and/or to define the plurality of interconnected tabs. As an example, the interlocking at 420 may include repeatedly interlocking a first portion of a strip interlock structure, which is defined by the interconnected leading tab of a given tab strip segment, with a second portion of the strip interlock structure, which is defined by the interconnected trailing tab of an adjacent tab strip segment. Examples of the strip interlock structure, the first portion of the strip interlock structure, the second portion of the strip interlock structure, and the plurality of interconnected tabs are disclosed herein with reference to strip interlock structure 280, first portion 281, second portion 282, and interconnected tabs 200.

Accordion folding, at 430, the first subset of the plurality of interconnected tabs may include accordion folding any suitable fraction, or subset, of the plurality of interconnected central tabs to form and/or define an accordion-folded stack of tabs. Examples of the accordion-folded stack of tabs are disclosed herein with reference to accordion-folded stack of tabs 204.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

Illustrative, non-exclusive examples of the tab strip segments, plurality of interconnected tabs, fastening devices, and methods, according to the present disclosure, are presented in the following enumerated paragraphs. It is within the scope of the present disclosure that an individual step of a method recited herein, including in the following enumerated paragraphs, may additionally or alternatively be referred to as a “step for” performing the recited action.

A1. A tab strip segment configured to be utilized in a fastening device, the tab strip segment comprising:

a plurality of interconnected central tabs, wherein each central tab of the plurality of interconnected central tabs includes:

(i) a tab body defining a first tab body surface and an opposed second tab body surface; and

(ii) at least a portion of an indexing structure configured to be operatively engaged by a tab advance mechanism of the fastening device and extending from at least one of the first tab body surface and the second tab body surface;

an interconnected leading tab arranged at a first end of the plurality of interconnected central tabs, wherein the interconnected leading tab defines a first leading tab surface, an opposed second leading tab surface, and a first portion of a strip interlock structure;

an interconnected trailing tab arranged at an opposed second end of the plurality of interconnected central tabs, wherein the interconnected trailing tab defines a first trailing tab surface, an opposed second trailing tab surface, and a second portion of the strip interlock structure; and

a plurality of tab attachment structures that operatively attaches the plurality of interconnected central tabs, the interconnected leading tab, and the interconnected trailing tab to one another to define the tab strip segment;

wherein the interconnected leading tab and the interconnected trailing tab are configured to overlap with one another such that the first portion of the strip interlock structure and the second portion of the strip interlock structure interlock with one another to facilitate assembly of a plurality of tab strip segments to define a tab strip;

wherein a combined thickness of the interconnected leading tab, as measured between the first leading tab surface and the second leading tab surface, and the interconnected trailing tab, as measured between the first trailing tab surface and the second trailing tab surface, is at least substantially matched to a thickness of each of the plurality of interconnected central tabs, as measured between the first tab body surface and the second tab body surface;

optionally wherein a first leading tab surface area of the first leading tab surface is at least substantially matched to a first tab body surface area of the first tab body surface; and

further optionally wherein a second trailing tab surface area of the second trailing tab surface is at least substantially matched to a second tab body surface area of the second tab body surface.

A2. The tab strip segment of paragraph A1, wherein, within each central tab, the first tab body surface is at least substantially parallel to the second tab body surface.

A3. The tab strip segment of any of paragraphs A1-A2, wherein the first tab body surface of each of the plurality of interconnected central tabs defines a maximum extent that is at least a threshold multiple of the thickness of each of the plurality of interconnected central tabs, wherein the threshold multiple is at least one of at least 5, at least 10, at least 25, at least 50, at least 100, at most 1000, at most 750, at most 500, at most 250, and at most 100.

A4. The tab strip segment of any of paragraphs A1-A3, wherein at least one of:

(i) the tab body is planar, or at least substantially planar;

(ii) the first tab body surface is planar, or at least substantially planar;

(iii) the second tab body surface is planar, or at least substantially planar;

(iv) the interconnected leading tab is planar, or at least substantially planar;

(v) the first leading tab surface is planar, or at least substantially planar;

(vi) the second leading tab surface is planar, or at least substantially planar;

(vii) the interconnected trailing tab is planar, or at least substantially planar;

(viii) the first trailing tab surface is planar, or at least substantially planar; and

(ix) the second trailing tab surface is planar, or at least substantially planar.

A5. The tab strip segment of any of paragraphs A1-A4, wherein a second leading tab surface area of the second leading tab surface is at least substantially matched to a first trailing tab surface area of the first trailing tab surface, optionally wherein a ratio of the second leading tab surface area to the first trailing tab surface area is at least 0.75, at least 0.80, at least 0.85, at least 0.90, at least 0.95, at least 0.99, 1.00, at most 1.01, at most 1.05, at most 1.10, at most 1.15, at most 1.20, and/or at most 1.25.

A6. The tab strip segment of any of paragraphs A1-A5, wherein, within each central tab, the at least the portion of the indexing structure at least one of:

(i) includes a projection, which is defined by the tab body, that projects from at least one of the first tab body surface and second tab body surface; and

(ii) includes a recess that extends into the tab body from at least one of the first tab body surface and the second tab body surface.

A7. The tab strip segment of any of paragraphs A1-A6, wherein the plurality of interconnected central tabs is at least one of:

(i) arranged sequentially within the tab strip segment; and

(ii) arranged end-to-end within the tab strip segment.

A8. The tab strip segment of any of paragraphs A1-A7, wherein each central tab is operatively attached to at least one and at most two other central tabs of the plurality of interconnected central tabs, optionally via corresponding tab attachment structures.

A9. The tab strip segment of any of paragraphs A1-A8, wherein the tab strip segment is an elongate tab strip segment that defines a longitudinal axis.

A10. The tab strip segment of any of paragraphs A1-A9, wherein the tab strip segment at least one of:

(i) is a monolithic tab strip segment;

(ii) is a unitary tab strip segment;

(iii) is an extruded tab strip segment;

(iv) is an injection molded tab strip segment; and

(v) is defined by a single tab strip segment body.

A11. The tab strip segment of any of paragraphs A1-A10, wherein the tab strip segment is formed from at least one of:

(i) a resilient material;

(ii) a polymeric material; and

(iii) a fibrous material.

A12. The tab strip segment of any of paragraphs A1-A11, wherein each tab attachment structure of the plurality of tab attachment structures includes at least one of:

(i) a perforated region;

(ii) a web;

(iii) a thin region relative to the thickness of each of the plurality of interconnected central tabs;

(iv) a weakened region relative to each of the plurality of interconnected central tabs;

(v) a reduced cross-sectional area region relative to the plurality of interconnected central tabs; and

(vi) a tapered region that tapers away from a corresponding pair of the plurality of interconnected central tabs.

A13. The tab strip segment of any of paragraphs A1-A12, wherein the tab strip segment is defined by a/the single tab strip segment body, and further wherein the plurality of tab attachment structures is fully defined by the single tab strip segment body.

A14. The tab strip segment of any of paragraphs A1-A13, wherein the plurality of tab attachment structures permits folding of each interconnected central tab of the plurality of interconnected central tabs relative to each adjacent interconnected central tab of the plurality of interconnected central tabs across a fold angle range of at least 180 degrees, optionally without separation of each interconnected central tab of the plurality of interconnected central tabs from each adjacent interconnected central tab of the plurality of interconnected central tabs, and further optionally to permit at least partial face-to-face contact between corresponding surfaces of adjacent interconnected central tabs of the plurality of interconnected central tabs.

A15. The tab strip segment of any of paragraphs A1-A14, wherein the plurality of tab attachment structures, the plurality of interconnected central tabs, the interconnected leading tab, and the interconnected trailing tab are shaped to permit the tab strip segment to be arranged in an accordion-folded fashion.

A16. The tab strip segment of any of paragraphs A1-A15, wherein, when the plurality of tab strip segments is assembled to define the tab strip, the first portion of the strip interlock structure of an interconnected leading tab of a first tab strip segment is interlocked with the second portion of the strip interlock structure of an interconnected trailing tab of a second tab strip segment such that the interconnected leading tab of the first tab strip segment and the interconnected trailing tab of the second tab strip segment together define a composite tab.

A17. The tab strip segment of paragraph A16, wherein the second leading tab surface and the first trailing tab surface at least one of:

(i) are parallel to one another;

(ii) face toward one another; and

(iii) are in direct physical contact with one another.

A18. The tab strip segment of any of paragraphs A16-A17, wherein the composite tab operatively interconnects a first plurality of interconnected central tabs of the first tab strip segment with a second plurality of interconnected central tabs of the second tab strip segment.

A19. The tab strip segment of any of paragraphs A16-A18, wherein at least one of:

(i) a shape of the composite tab is at least substantially similar to a shape of each of the plurality of interconnected central tabs;

(ii) the composite tab defines a composite tab indexing structure that is at least substantially similar to the at least the portion of the indexing structure of each central tab of the plurality of interconnected central tabs; and

(iii) a thickness of the composite tab is at least substantially similar to the thickness of each of the plurality of interconnected central tabs.

A20. The tab strip segment of any of paragraphs A16-A19, wherein the first portion of the strip interlock structure includes an interlock structure opening defined within the interconnected leading tab of the first tab strip segment, wherein the second portion of the strip interlock structure includes an interlock structure projection that projects from the first trailing tab surface of the interconnected trailing tab of the second tab strip segment, and further wherein the interlock structure projection is sized to be received within, and to interlock with, the interlock structure opening.

A21. The tab strip segment of paragraph A20, wherein the interlock structure projection projects from the first leading tab surface of the interconnected leading tab of the first tab strip segment to define a/the composite tab indexing structure of the composite tab.

B1. A plurality of interconnected tabs that defines a tab strip, the plurality of interconnected tabs comprising:

a plurality of tab strip segments of any of paragraphs A1-A21, wherein:

(i) the plurality of tab strip segments includes at least one central tab strip segment, a leading tab strip segment, and a trailing tab strip segment;

(ii) the at least one central tab strip segment extends between, and operatively interconnects, the leading tab strip segment and the trailing tab strip segment; and

(iii) the first portion of the strip interlock structure of the interconnected leading tab of each of the at least one central tab strip segments is operatively interlocked with the second portion of the strip interlock structure of the interconnected trailing tab of an adjacent tab strip segment of the plurality of tab strip segments to define the plurality of interconnected tabs.

B2. The plurality of interconnected tabs of paragraph B1, wherein the plurality of tab strip segments includes at least 2, at least 5, at least 10, at least 20, at least 30, at least 40, or at least 50 tab strip segments.

B3. The plurality of interconnected tabs of any of paragraphs B1-B2, wherein the plurality of interconnected tabs includes at least 10, at least 25, at least 50, at least 100, at least 200, at least 300, at least 400, or at least 500 interconnected tabs.

C1. An accordion-folded stack of tabs, comprising:

the plurality of interconnected tabs of any of paragraphs B1-B3, wherein:

(i) the plurality of interconnected tabs is arranged in a plurality of tab layers; and

(ii) each tab layer of the plurality of tab layers is operatively attached to at least one other tab layer of the plurality of tab layers via a corresponding tab attachment structure of the plurality of tab attachment structures.

C2. The accordion-folded stack of tabs of paragraph C1, wherein each tab layer of the plurality of tab layers is at least substantially parallel to each other tab layer of the plurality of tab layers.

C3. The accordion-folded stack of tabs of any of paragraphs C1-C2, wherein each tab layer of the plurality of tab layers is defined by a corresponding subset of the plurality of interconnected tabs.

C4. The accordion-folded stack of tabs of paragraph C3, wherein the first tab body surface of the corresponding subset of the plurality of interconnected tabs in a given tab layer of the plurality of tab layers faces toward, or physically contacts, the first tab body surface of the corresponding subset of the plurality of interconnected tabs in an adjacent tab layer of the plurality of tab layers.

C5. The accordion-folded stack of tabs of any of paragraphs C3-C4, wherein the second tab body surface of the corresponding subset of the plurality of interconnected tabs in a/the given tab layer of the plurality of tab layers faces toward, or physically contacts, the second tab body surface of the corresponding subset of the plurality of interconnected tabs in an/the adjacent tab layer of the plurality of tab layers.

C6. The accordion-folded stack of tabs of any of paragraphs C1-C5, wherein each tab layer of the plurality of tab layers includes 1, 2, 3, 4, 5, at least 1, at least 2, at least 3, at least 4, at most 10, at most 8, at most 6, at most 4, and/or at most 2 tabs.

C7. The accordion-folded stack of tabs of any of paragraphs C1-C6, wherein the plurality of tab layers includes at least 5, at least 10, at least 15, at least 20, at least 25, at least 30, at least 40, at least 50, at least 60, at least 70, at least 80, at least 90, or at least 100 tab layers.

D1. A fastening device, comprising:

a handle configured to be gripped by a user;

a trigger mechanism configured to be actuated by the user;

a fastener magazine configured to contain a plurality of fasteners;

a fastening head defining a fastening region;

a tab strip that includes at least a first subset of the plurality of interconnected tabs of any of paragraphs B1-B3; and

a tab feed structure configured to selectively advance the tab strip toward the fastening region.

D2. The fastening device of paragraph D1, wherein the tab feed structure is configured to contain a second subset of the plurality of interconnected tabs.

D3. The fastening device of paragraph D2, wherein the tab feed structure includes a tab magazine configured to contain the second subset of the plurality of interconnected tabs.

D4. The fastening device of paragraph D3, wherein the tab magazine is configured to contain at least one of:

(i) an accordion-folded stack of tabs that is formed from the second subset of the plurality of interconnected tabs;

(ii) a roll of tabs that is formed from the second subset of the plurality of interconnected tabs; and

(iii) a stored tab strip that is formed from the second subset of the plurality of interconnected tabs.

D5. The fastening device of any of paragraphs D1-D4, wherein the tab feed structure further includes a feed rail configured to receive the tab strip, optionally from the tab magazine, and to direct the tab strip, optionally from the tab magazine, toward the fastening region.

D6. The fastening device of any of paragraphs D1-D5, wherein the tab feed structure further includes a tab advance mechanism configured to selectively advance the tab strip toward the fastening region.

E1. A method of forming a plurality of interconnected tabs, the method comprising:

providing a plurality of tab strip segments, wherein each tab strip segment of the plurality of tab strip segments includes a plurality of interconnected central tabs, an interconnected leading tab arranged on a first end of the plurality of interconnected central tabs, and an interconnected trailing tab arranged on an opposed second end of the plurality of interconnected central tabs; and

interlocking the plurality of tab strip segments to form the plurality of interconnected tabs, wherein the interlocking includes repeatedly interlocking a first portion of a strip interlock structure, which is defined by the interconnected leading tab of a given tab strip segment of the plurality of tab strip segments, with a second portion of the strip interlock structure, which is defined by the interconnected trailing tab of an adjacent tab strip segment of the plurality of tab strip segments.

E2. The method of paragraph E1, wherein the plurality of tab strip segments includes the tab strip segment of any of paragraphs A1-A21.

E3. The method of any of paragraphs E1-E2, wherein the plurality of interconnected tabs includes the plurality of interconnected tabs of any of paragraphs B1-B3.

E4. The method of any of paragraphs E1-E3, wherein the method further includes accordion-folding at least a first subset of the plurality of interconnected tabs to define an accordion-folded stack of tabs.

E5. The method of paragraph E4, wherein the accordion-folded stack of tabs includes the accordion-folded stack of tabs of any of paragraphs C1-C7.

### INDUSTRIAL APPLICABILITY

The tab strip segments, pluralities of interconnected tabs, fastening devices, and methods disclosed herein are applicable to the tab fastening, fastening device, and lumber wrap industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A tab strip segment configured to be utilized in a fastening device, the tab strip segment comprising:
a plurality of interconnected central tabs, wherein each central tab of the plurality of interconnected central tabs includes:
(i) a tab body defining a first tab body surface and an opposed second tab body surface; and
(ii) at least a portion of an indexing structure configured to be operatively engaged by a tab advance mechanism of the fastening device and extending from at least one of the first tab body surface and the second tab body surface;
an interconnected leading tab arranged at a first end of the plurality of interconnected central tabs, wherein the interconnected leading tab defines a first leading tab surface, an opposed second leading tab surface, and a first portion of a strip interlock structure;
an interconnected trailing tab arranged at an opposed second end of the plurality of interconnected central tabs, wherein the interconnected trailing tab defines a first trailing tab surface, an opposed second trailing tab surface, and a second portion of the strip interlock structure; and
a plurality of tab attachment structures that operatively attaches the plurality of interconnected central tabs, the interconnected leading tab, and the interconnected trailing tab to one another to define the tab strip segment;
wherein the interconnected leading tab and the interconnected trailing tab are configured to overlap with one another such that the first portion of the strip interlock structure and the second portion of the strip interlock structure interlock with one another to facilitate assembly of a plurality of tab strip segments to define a tab strip; and
further wherein a combined thickness of the interconnected leading tab, as measured between the first leading tab surface and the second leading tab surface, and the interconnected trailing tab, as measured between the first trailing tab surface and the second trailing tab surface, is at least substantially matched to a thickness of each interconnected central tab of the plurality of interconnected central tabs, as measured between the first tab body surface and the second tab body surface.

2. The tab strip segment of claim 1, wherein:
(i) a first leading tab surface area of the first leading tab surface is at least substantially matched to a first tab body surface area of the first tab body surface; and
(ii) a second trailing tab surface area of the second trailing tab surface is at least substantially matched to a second tab body surface area of the second tab body surface.

3. The tab strip segment of claim 1, wherein the first tab body surface of each interconnected central tab of the plurality of interconnected central tabs defines a maximum extent that is at least 10 times the thickness of each interconnected central tab of the plurality of interconnected central tabs.

4. The tab strip segment of claim 1, wherein a second leading tab surface area of the second leading tab surface is at least substantially matched to a first trailing tab surface area of the first trailing tab surface, wherein a ratio of the second leading tab surface area to the first trailing tab surface area is at least 0.75 and at most 1.25.

5. The tab strip segment of claim 1, wherein, within each interconnected central tab of the plurality of interconnected central tabs, the first tab body surface is at least substantially parallel to the second tab body surface.

6. The tab strip segment of claim 1, wherein, within each interconnected central tab of the plurality of interconnected central tabs, the at least the portion of the indexing structure at least one of:
(i) includes a projection, which is defined by the tab body, that projects from at least one of the first tab body surface and second tab body surface; and
(ii) includes a recess that extends into the tab body from at least one of the first tab body surface and the second tab body surface.

7. The tab strip segment of claim 1, wherein each interconnected central tab of the plurality of interconnected central tabs is operatively attached to at least one and at most two other interconnected central tabs of the plurality of interconnected central tabs via corresponding tab attachment structures.

8. The tab strip segment of claim 1, wherein each tab attachment structure of the plurality of tab attachment structures includes at least one of:
(i) a perforated region;
(ii) a web;
(iii) a thin region relative to the thickness of each interconnected central tab of the plurality of interconnected central tabs;
(iv) a weakened region relative to each interconnected central tab of the plurality of interconnected central tabs;
(v) a reduced cross-sectional area region relative to the plurality of interconnected central tabs; and
(vi) a tapered region that tapers away from a corresponding pair of the plurality of interconnected central tabs.

9. The tab strip segment of claim 1, wherein the tab strip segment is defined by a single tab strip segment body, and further wherein the plurality of tab attachment structures is fully defined by the single tab strip segment body.

10. The tab strip segment of claim 1, wherein the plurality of tab attachment structures permits folding of each interconnected central tab of the plurality of interconnected central tabs relative to each adjacent interconnected central tab of the plurality of interconnected central tabs across a fold angle range of at least 180 degrees, optionally without separation of each interconnected central tab of the plurality of interconnected central tabs from each adjacent interconnected central tab of the plurality of interconnected central tabs, and further optionally to permit at least partial face-to-face contact between corresponding surfaces of adjacent interconnected central tabs of the plurality of interconnected central tabs.

11. A plurality of interconnected tabs that defines a tab strip, the plurality of interconnected tabs comprising:
a plurality of tab strip segments of claim 1, wherein:
(i) the plurality of tab strip segments includes a plurality of central tab strip segments, a leading tab strip segment, and a trailing tab strip segment;
(ii) the plurality of central tab strip segments extends between, and operatively interconnects, the leading tab strip segment and the trailing tab strip segment; and
(iii) the first portion of the strip interlock structure of the interconnected leading tab of each central tab strip segment of the plurality of central tab strip segments is operatively interlocked with the second portion of the strip interlock structure of the interconnected trailing tab of an adjacent tab strip segment of the plurality of tab strip segments to define the plurality of interconnected tabs.

12. The plurality of interconnected tabs of claim 11, wherein the interconnected leading tab of each central tab strip segment of the plurality of central tab strip segments and the interconnected trailing tab of the adjacent tab strip segment of the plurality of central tab strip segments together define a composite tab.

13. The plurality of interconnected tabs of claim 12, wherein at least one of:
(i) a shape of the composite tab is at least substantially similar to a shape of each interconnected central tab of the plurality of interconnected central tabs;
(ii) the composite tab defines a composite tab indexing structure that is at least substantially similar to the at least the portion of the indexing structure of each interconnected central tab of the plurality of interconnected central tabs; and
(iii) a thickness of the composite tab is at least substantially similar to the thickness of each interconnected central tab of the plurality of interconnected central tabs.

14. The plurality of interconnected tabs of claim 11, wherein the second leading tab surface of the interconnected leading tab of each central tab strip segment of the plurality of central tab strip segments and the first trailing tab surface of the interconnected trailing tab of the adjacent tab strip segment of the plurality of tab strip segments at least one of:
(i) are parallel to one another;
(ii) face toward one another; and
(iii) are in direct physical contact with one another.

15. The plurality of interconnected tabs of claim 11, wherein the first portion of the strip interlock structure of the interconnected leading tab of each central tab strip segment of the plurality of central tab strip segments includes an interlock structure opening defined within the corresponding interconnected leading tab, wherein the second portion of the strip interlock structure of the interconnected trailing tab of the adjacent tab strip segment includes an interlock structure projection that projects from the first trailing tab surface of the adjacent tab strip segment, and further wherein the interlock structure projection is sized to be received within, and to interlock with, the interlock structure opening.

16. An accordion-folded stack of tabs, comprising:
the plurality of interconnected tabs of claim 11, wherein:
(i) the plurality of interconnected tabs is arranged in a plurality of tab layers; and
(ii) each tab layer of the plurality of tab layers is operatively attached to at least one other tab layer of the plurality of tab layers via a corresponding tab attachment structure of the plurality of tab attachment structures.

17. The accordion-folded stack of tabs of claim 16, wherein each tab layer of the plurality of tab layers is at least substantially parallel to each other tab layer of the plurality of tab layers.

18. A fastening device, comprising:
a handle configured to be gripped by a user;
a trigger mechanism configured to be actuated by the user;
a fastener magazine configured to contain a plurality of fasteners;
a fastening head defining a fastening region; and
a tab feed structure, including:
(i) a tab magazine configured to contain an accordion-folded stack of tabs, which is formed from a first subset of the plurality of interconnected tabs of claim 16;
(ii) a feed rail configured to receive a tab strip, which is formed from a second subset of the plurality of interconnected tabs, from the tab magazine and to direct the tab strip from the tab magazine toward the fastening region; and
(iii) a tab advance mechanism configured to selectively advance the tab strip toward the fastening region.

19. A method of forming a plurality of interconnected tabs, the method comprising:
providing a plurality of tab strip segments, wherein each tab strip segment of the plurality of tab strip segments includes a plurality of interconnected central tabs, an interconnected leading tab arranged on a first end of the plurality of interconnected central tabs, and an interconnected trailing tab arranged on an opposed second end of the plurality of interconnected central tabs; and
interlocking the plurality of tab strip segments to form the plurality of interconnected tabs, wherein the interlocking includes repeatedly interlocking a first portion of a strip interlock structure, which is defined by the interconnected leading tab of a given tab strip segment of the plurality of tab strip segments, with a second portion of the strip interlock structure, which is defined by the interconnected trailing tab of an adjacent tab strip segment of the plurality of tab strip segments.

20. The method of claim 19, wherein the method further includes accordion-folding at least a first subset of the plurality of interconnected tabs to define an accordion-folded stack of tabs.
